(19) United States
(12) Patent Application Publication
(10) Pub. No.: US 2025/0329858 A1
(43) Pub. Date: Oct. 23, 2025

(54) ENERGY STORAGE POWER SUPPLY

(71) Applicant: SHENZHEN HELLO TECH ENERGY CO., LTD, Shenzhen (CN)

(72) Inventors: Foming ZHANG, Shenzhen (CN); Jie ZHANG, Shenzhen (CN); Zhongwei SUN, Shenzhen (CN); Rao FU, Shenzhen (CN)

(21) Appl. No.: 19/251,862

(22) Filed: Jun. 27, 2025

Related U.S. Application Data
(63) Continuation of application No. PCT/CN2025/072700, filed on Jan. 16, 2025.

(30) Foreign Application Priority Data
Aug. 30, 2024 (CN) 202411223574.5
Aug. 30, 2024 (CN) 202422140847.1

(51) Int. Cl. H01M 50/291; H01M 10/42; H01M 50/143; H01M 50/284; H01M 50/342; H01M 50/507

(52) U.S. Cl. CPC H01M 50/291; H01M 10/425; H01M 50/143; H01M 50/284; H01M 50/3425; H01M 50/507

(57) ABSTRACT

Provided is an energy storage power supply, which includes a shell having an accommodation chamber, the accommodation chamber being provided with a first support, the first support having one or more first accommodation recesses, and each of the one or more first accommodation recesses having a first through hole at a bottom of the first accommodation recess; a battery cell located in the accommodation chamber and disposed at the first support, the battery cell including a main body, and the main body having an end fitted in a corresponding first accommodation recess of the one or more first accommodation recesses; a second support fixedly connected to the shell and disposed at a side of the battery cell away from the first support, the battery cell being sandwiched between the first support and the second support; and an inverter located in the accommodation chamber and electrically connected to the battery cell.

### CROSS-REFERENCE TO RELATED APPLICATION

The present application is a continuation application of International Application No. PCT/CN2025/072700, filed on Jan. 16, 2025, which claims priorities to and benefits of Chinese Patent Applications Nos. 202411223574.5 and 202422140847.1, filed with China National Intellectual Property Administration on Aug. 30, 2024, the entire contents of each of which are incorporated herein by reference for all purposes.

### FIELD

The present disclosure relates to the field of energy storage technologies, and in particular, to an energy storage power supply.

### BACKGROUND

In an energy storage product of related art, in order to ensure that a battery module can be stably held inside a shell, it is necessary to firmly assemble battery cells into a battery module using two battery supports. Then, the assembled battery module is placed inside the shell. However, this approach results in a heavy weight and a large volume of the energy storage product, reducing portability and increasing manufacturing costs of the energy storage product. Moreover, the battery module is fixed inside the shell by a screw, and thus stress concentration occurs at a fixed connection between the battery module and the shell, which is likely to cause a risk of fracture under impact.

### SUMMARY

Embodiments of the present disclosure provide an energy storage power supply to solve at least one of the above technical problems.

An energy storage power supply according to an embodiment of the present disclosure includes: a shell having an accommodation chamber and a receiving space, in which the accommodation chamber is provided with a first support at an inner side surface of the accommodation chamber, the first support having a plurality of first accommodation recesses, and each of the plurality of first accommodation recesses having a first through hole at a bottom of the first accommodation recess; a battery cell located in the accommodation chamber and disposed at the first support, the battery cell including a main body and two electrodes respectively disposed at two ends of the main body in a length direction of the main body, and the main body having an end fitted in a corresponding first accommodation recess of the plurality of first accommodation recesses and being in communication with the receiving space through the first through hole; a second support fixedly connected to the shell and disposed at a side of the battery cell away from the first support, the battery cell being sandwiched between the first support and the second support; and an inverter located in the accommodation chamber and electrically connected to the battery cell.

In the above energy storage power supply, the shell is provided with the first support at an inner surface of the shell facing the accommodation chamber, and the battery cell is disposed at the first support, in such a manner that the shell can integrate a support function, which can reduce a volume and a weight of the energy storage power supply to some extent, improving portability and lowering manufacturing costs of the energy storage power supply. Further, the battery cell can disperse an overall stress to the entire shell through the first support, which can reduce localized stress concentration to enhance impact resistance of a product to some extent.

In some embodiments, the energy storage power supply further includes a first busbar disposed in the receiving space, the first busbar being electrically connected to a first electrode of the two electrodes of the battery cell through the first through hole, and the first electrode being formed at the end of the main body fitted in the corresponding first accommodation recess of the plurality of first accommodation recesses.

In some embodiments, the energy storage power supply further includes a cover plate, the shell having a receiving chamber formed at an outer side surface of the shell corresponding to the first support, the cover plate being disposed at the outer side surface of the shell and covering the receiving chamber to form the receiving space, and the first busbar being disposed in the receiving space.

In some embodiments, the energy storage power supply further includes a first acquisition board disposed in the receiving space and electrically connected to the first busbar.

In some embodiments, the second support has a plurality of second accommodation recesses, the main body having another end fitted in a corresponding second accommodation recess of the plurality of second accommodation recesses.

In some embodiments, the energy storage power supply further includes a second busbar located in the accommodation chamber, each of the plurality of second accommodation recesses having a second through hole at a bottom surface of the second accommodation recess, the second busbar being connected to a second electrode of the two electrodes of the battery cell through the second through hole, and the second electrode being formed at the other end of the main body fitted in the corresponding second accommodation recess of the plurality of second accommodation recesses.

In some embodiments, the energy storage power supply further includes a second acquisition board located in the accommodation chamber and electrically connected to the second busbar.

In some embodiments, the energy storage power supply further includes a battery management circuit board disposed in the accommodation chamber. The first busbar is electrically connected to the battery management circuit board. The inverter is disposed at a side of the battery management circuit board away from the first busbar.

In some embodiments, the accommodation chamber has a third through hole at a side wall of the accommodation chamber, the receiving space being in communication with the accommodation chamber through the third through hole, and the first busbar being electrically connected to the battery management circuit board through the third through hole.

In some embodiments, the first electrode is provided with an explosion-proof valve, the explosion-proof valve being in communication with the receiving space through the first through hole.

In some embodiments, the inverter is disposed at a side of the second support away from the battery cell.

In some embodiments, the second support is provided with a plurality of connection bases protruding from a side surface of the second support away from the battery cell, the inverter being mounted on the plurality of connection bases.

In some embodiments, the first support is provided with a first connection member; and the second support is provided with a second connection member, the first connection member being connected to the second connection member to allow the battery cell to be sandwiched by the first support and the second support.

In some embodiments, the shell includes a first housing and a second housing connected to the first housing, the first support and the first housing being integrally formed.

In some embodiments, the second housing is provided with a handle.

In some embodiments, the first housing is provided with a first connection post inside the first housing; and the second housing is provided with a second connection post inside the second housing, the first connection post being connected to the second connection post to connect the first housing to the second housing.

In some embodiments, the energy storage power supply further includes a panel, the shell having a first opening at which the panel is mounted.

In some embodiments, the shell includes a first housing and a second housing. The first housing has a first groove. The second housing has a second groove, the first housing being connected to the second housing, in such a manner that the first groove and the second groove are joined to form the first opening. The first housing has a first connection recess. The second housing has a second connection recess. The panel is provided with two first connection tabs, the two first connection tabs being respectively inserted into the first connection recess and the second connection recess to enable the panel to be mounted at the first opening.

In some embodiments, the shell has a second opening; and the energy storage power supply further includes a ventilation panel mounted at the second opening.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

In order to clearly explain technical solutions of embodiments of the present disclosure or in the related art, drawings used in description of the embodiments or the related art are briefly described below. Obviously, the drawings as described below are merely some embodiments of the present disclosure. Based on structures illustrated by these drawings, other drawings can be obtained by those skilled in the art without creative effort.

FIG. 1 and FIG. 2 each are a schematic structural view of an energy storage power supply according to an embodiment of the present disclosure.

FIG. 3 to FIG. 9 each are a schematic exploded view of an energy storage power supply according to an embodiment of the present disclosure.

Description of reference numerals of the accompanying drawings:

energy storage power supply 100, shell 12, battery cell 14, inverter 16, accommodation chamber 18, first support 20, first housing 22, second housing 24, panel 26, first accommodation recess 28, main body 30, first busbar 32, first through hole 34, first electrode 36, receiving chamber 38, first acquisition board 40, cover plate 42, battery management circuit board 44, second support 46, second accommodation recess 48, second busbar 50, second through hole 52, second electrode 54, second acquisition board 56, third through hole 57, spacer 58, explosion-proof valve 59, connection base 60, accommodation space 62, first connection member 64, second connection member 66, first connection post 68, second connection post 70, first connection hole 72, second connection hole 74, first opening 76, first groove 78, second groove 80, first connection recess 82, second connection recess 84, second opening 86, ventilation panel 88, third groove 90, fourth groove 92, third connection recess 94, fourth connection recess 96, heat dissipation fan 98, handle 97, foot pad 95.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the description of the present disclosure, it should be understood that, the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, and “anti-clockwise” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In addition, terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, unless otherwise specifically defined.

In the description of the present disclosure, it should be noted that, unless otherwise clearly specified and limited, terms such as “install”, “connect”, and “connect to” should be understood in a broad sense. For example, it may be a fixed connection or a detachable connection or connection as one piece; mechanical connection or electrical connection; direct connection or indirect connection through an intermediate; internal communication of two components or the interaction relationship between two components. For those of ordinary skill in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

Various embodiments or examples for implementing different structures of the present disclosure are provided below. In order to simplify the description of the present disclosure, components and arrangements of specific examples are described herein. These specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed arrangements. In addition, the present disclosure provides examples of various specific processes and materials. However, applications of other processes and/or the use of other materials are conceivable for those of ordinary skill in the art.

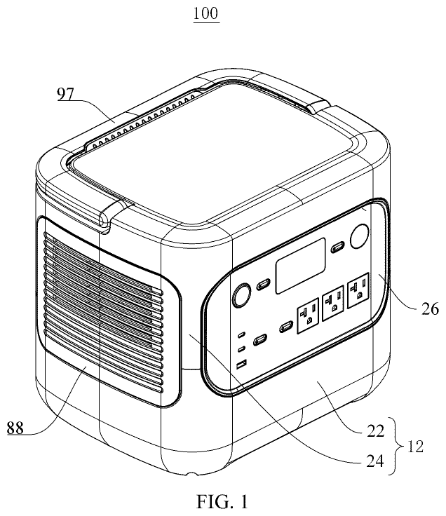

With reference to FIG. 1 to FIG. 8, an energy storage power supply 100 according to the embodiments of the present disclosure includes a shell 12, a battery cell 14, a second support 46, and an inverter 16. The shell 12 has an accommodation chamber 18 and a receiving space. The accommodation chamber 18 is provided with a first support 20 at an inner side surface of the accommodation chamber 18. The first support 20 has a plurality of first accommodation recesses 28. Each of the plurality of first accommodation recesses 28 has a first through hole 34 at a bottom of the first accommodation recess 28.

The battery cell 14 is located in the accommodation chamber 18 and disposed at the first support 20. The battery cell 14 includes a main body 30 and two electrodes respectively disposed at two ends of the main body 30 in a length direction of the main body 30. The main body 30 has an end fitted in a corresponding first accommodation recess 28 of the plurality of first accommodation recesses 28 and is in communication with the receiving space through the first through hole 34.

The second support 46 is disposed in the accommodation chamber 18 and fixedly connected to the shell 12. The second support 46 is disposed at a side of the battery cell 14 away from the first support 20. The battery cell 14 is sandwiched between the first support 20 and the second support 46. The inverter 16 is located in the accommodation chamber 18 and electrically connected to the battery cell 14.

In the above energy storage power supply 100, the shell 12 is provided with the first support 20 at an inner surface of the shell 12 facing the accommodation chamber 18, and the battery cell 14 is disposed at the first support 20, in such a manner that the shell 12 can integrate a support function, which can reduce a volume and a weight of the energy storage power supply 100 to some extent, improving portability and lowering manufacturing costs of the energy storage power supply 100. Further, the battery cell 14 can disperse an overall stress to the entire shell 12 through the first support 20, which can reduce localized stress concentration to enhance impact resistance of a product to some extent.

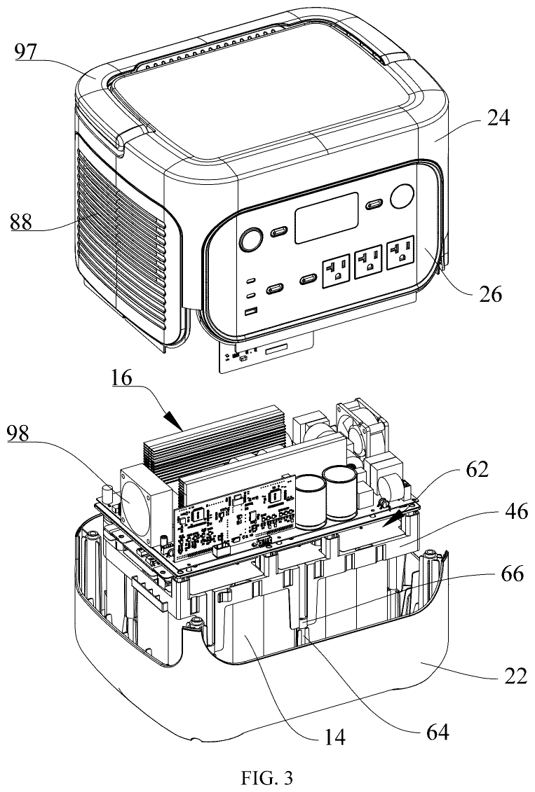

Specifically, the shell 12 is used to encase electrical components such as the battery cell 14 and the inverter 16. The shell 12 is made of a material including, but not limited to, plastic, metal, and the like. Alternatively, in the embodiments of the present disclosure, the shell 12 includes a first housing 22 and a second housing 24. In FIG. 3 to FIG. 9, the shell 12 has an upper-lower structure, the first housing 22 is used as a lower housing of the energy storage power supply 100, and the second housing 24 is used as an upper housing of the energy storage power supply 100. In some embodiments, the first housing 22 may be used as the lower housing of the energy storage power supply 100, and the second housing 24 may be used as the upper housing of the energy storage power supply 100. In some embodiments, the shell 12 may have a left-right structure, with the first housing 22 serving as a left housing or a right housing of the energy storage power supply 100 and the second housing 24 as the right housing or the left housing of the energy storage power supply 100.

In the illustrated embodiments, each of the first housing 22 and the second housing 24 has a hollow structure having an open side. The open side of the first housing 22 and the open side of the second housing 24 are connected to form the accommodation chamber 18 defined by the first housing 22 and the second housing 24 together. In other embodiments, one of the first housing 22 and the second housing 24 may have a hollow structure having an open side, while another of the first housing 22 and the second housing 24 may have a plate-like structure which covers the open side of the one of the first housing 22 and the second housing 24 that have the hollow structure, in such a manner that the first housing 22 and the second housing 24 form the accommodation chamber 18 together. A shape of the shell 12 may include, but is not limited to, a cylinder, a cuboid, and the like.

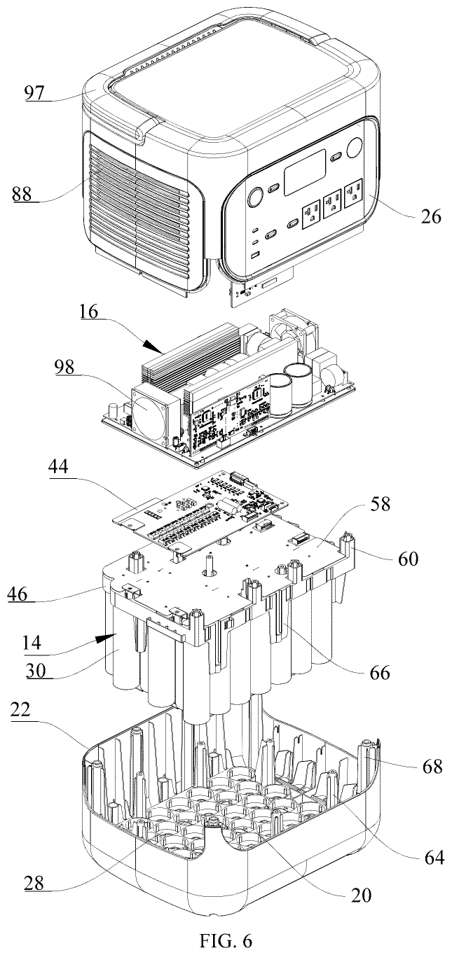

Alternatively, in an embodiment, with reference to FIG. 6, the first housing 22 and the first support 20 are integrally formed. As an example, the shell 12 is made of plastic. The first housing 22 and the first support 20 may be integrally manufactured using an injection molding process, reducing assembly steps of the first housing 22 and the first support 20 and reinforcing a connection between the first housing 22 and the first support 20.

Alternatively, in an embodiment, the first housing 22 and the first support 20 may have split structures. The first housing 22 and the first support 20 are separately manufactured, and then the first support 20 is fixed in the first housing 22.

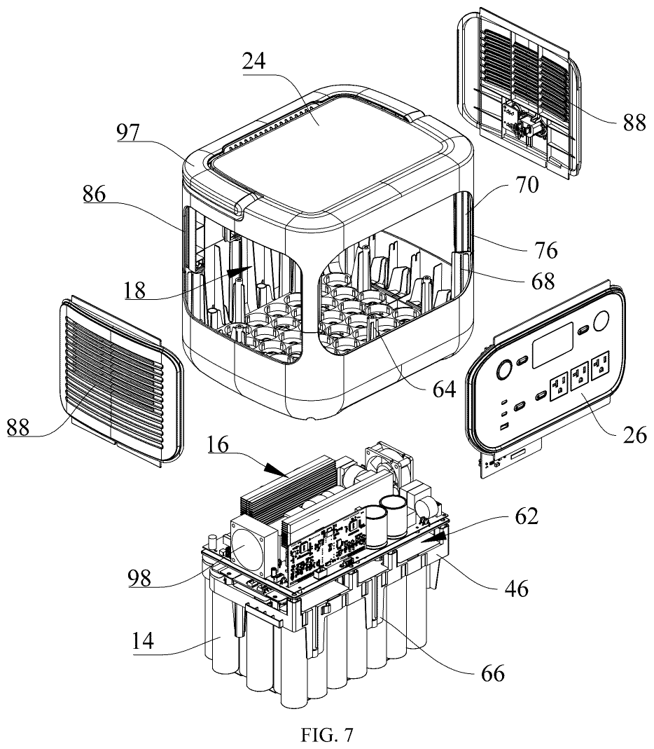

The battery cell 14 may be disposed in the accommodation chamber 18, and thus the shell 12 can provide protection for the battery cell 14. The battery cell 14 may be a secondary battery or a primary battery. The battery cell 14 may also be a lithium-sulfur battery, a sodium- ion battery, or a magnesium-ion battery, but is not limited to any of these examples. The battery cell 14 may be in a shape of a cylinder, a flat body, a cuboid, or the like. In FIG. 7, the battery cell 14 is in a shape of a cylinder.

One or more battery cells 14 are disposed in the accommodation chamber 18. The plurality of battery cells 14 may be electrically connected in series, in parallel, or in series- parallel. That “in series-parallel” may refer to that the plurality of battery cells 14 are connected in series and in parallel.

In FIG. 6, the inverter 16 is disposed at the side of the battery cell 14 away from the first support 20. The inverter 16 is disposed in the accommodation chamber 18, and thus the shell 12 can provide protection for the inverter 16. The inverter 16 is electrically connected to the battery cell 14 and can convert a direct current from the battery cell 14 into an alternating current to supply power to appliances using alternating currents. Alternatively, the energy storage power supply 100 may also output a direct current to supply power to electronic devices using direct currents.

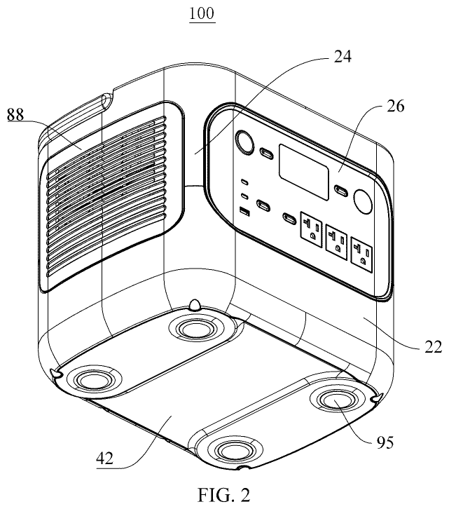

With reference to FIG. 1 and FIG. 2, the energy storage power supply 100 includes a panel 26. The panel 26 is mounted at an outer side surface of the shell 12 away from the accommodation chamber 18. The panel 26 is provided with, but not limited to, an input interface, an output interface, a switch button, a display screen, and a light lamp. The output interface includes an AC (alternating current) output port, a DC (direct current) output port, a vehicle charging output port, a USB output port, etc. The input interface includes an AC input port and a DC input port. The switch button is configured to turn on or turn off a corresponding input interface. The energy storage power supply 100 can be powered (e.g., the battery cell 14 can be charged) by an external power supply (such as mains electricity, photovoltaic, direct current, etc.). The display screen can be configured to display information such as a battery level, input power, output power, etc., of the energy storage power supply 100. The light can be used for illumination.

Alternatively, in an embodiment, the energy storage power supply 100 according to the embodiments of the present disclosure can be applied in an outdoor power supply for a user to use outdoors. For example, during camping, the user can use the energy storage power supply 100 to power or charge appliances, lights, mobile phones, tablet computers, etc.

Alternatively, in an embodiment, the energy storage power supply 100 according to the embodiments of the present disclosure can also be applied in an indoor power supply for the user to use indoors. For example, the user can charge the energy storage power supply 100 using an external power supply. In the event of a power outage at home, the user can use the energy storage power supply 100 to power appliances, lights, mobile phones, tablet computers, etc.

The main body 30 may include a case and an electrode assembly located in the case. The electrode assembly may be an assembly where electrochemical reactions occur within the battery cell 14. The electrode assembly may be formed by winding or laminating a positive sheet and a negative sheet, with a separator arranged between the positive sheet and the negative plate. The positive sheet is provided with a positive tab. The negative sheet is provided with a negative tab. The positive tab and the negative tab are respectively connected to two electrodes of opposite polarities via connection pieces.

In FIG. 6, the length direction of the main body 30 is an up-down direction. The two electrodes are an upper electrode and a lower electrode. The upper electrode and the lower electrode are formed at an upper end and a lower end of the main body 30, respectively. The main body 30 has the lower end fitted in the corresponding first accommodation recess 28 of the plurality of first accommodation recesses 28 and is in communication with the receiving space through the first through hole 34.

Alternatively, the plurality of first accommodation recesses 28 are arranged in a matrix, and thus the plurality of battery cells 14 are also arranged in a matrix. In this way, the plurality of battery cells 14 are arranged in an organized manner, which is conducive to improving space utilization of the energy storage power supply 100. A shape of the first accommodation recess 28 matches with that of the main body 30 to fix and limit the battery cell 14 more effectively. In FIG. 6, the main body 30 is in a shape of a cylinder, and correspondingly, the first accommodation recess 28 is also in a shape of a cylinder.

The first accommodation recess 28 can constrain the battery cell 14 to prevent the battery cell 14 from shaking during use of the energy storage power supply 100, which could otherwise affect normal use of the energy storage power supply 100.

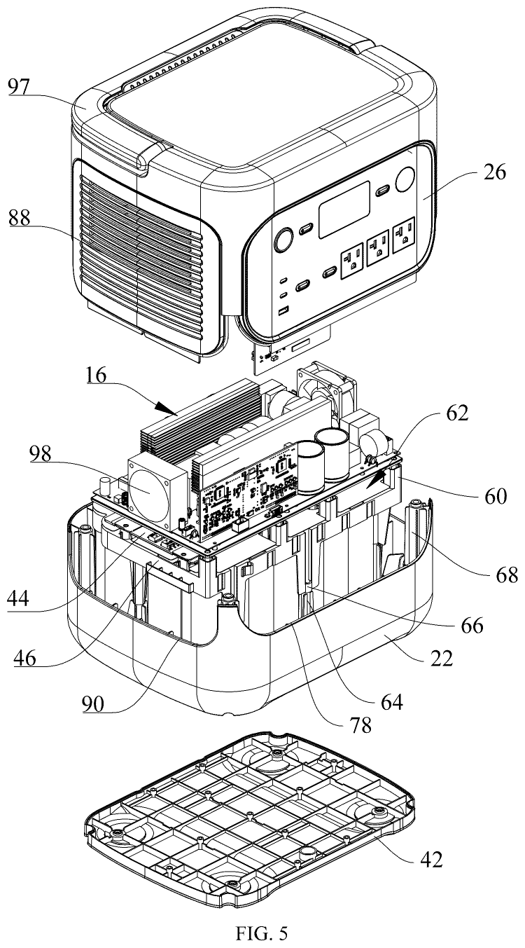

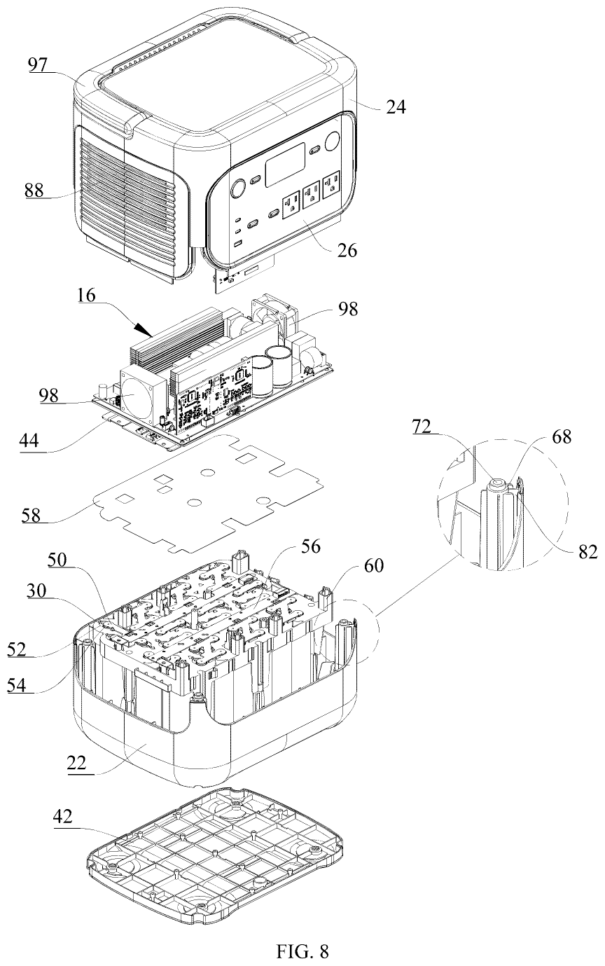

The second support 46 can further enhance stability of the battery cell 14. Specifically, with reference to FIG. 5, FIG. 6, and FIG. 8, the first support 20 and the second support 46 can sandwich the battery cell 14 in the up-down direction, enabling the battery cell 14 to be more stably fixed in the accommodation chamber 18. The inverter 16 may be disposed at a side of the second support 46 away from the battery cell 14, in such a manner that the second support 46 can be used to fix the inverter 16, which can reduce a need for an additional component for fixing the inverter 16. In this way, the volume and the weight of the energy storage power supply 100 can be reduced to some extent, improving the portability and lowering the manufacturing costs of the energy storage power supply 100.

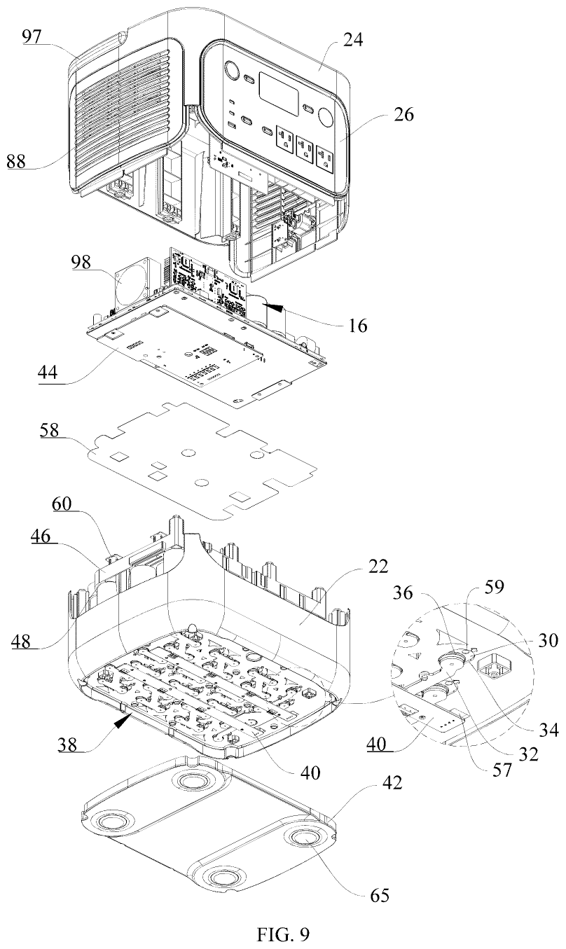

In some embodiments, with reference to FIG. 9, the energy storage power supply 100 includes a first busbar 32 disposed in the receiving space. The first busbar 32 is connected to a first electrode 36 of the two electrodes of the battery cell 14 through the first through hole 34. The first electrode 36 is formed at the end of the main body 30 fitted in the corresponding first accommodation recess 28 of the plurality of first accommodation recesses 28.

In the way, the plurality of battery cells 14 can be electrically connected by the first busbar 32.

Specifically, in an embodiment, with reference to FIG. 9, the first electrode 36 may pass through the first through hole 34 and be connected to the first busbar 32. In an embodiment, the first busbar 32 may pass through the first through hole 34 and be connected to the first electrode 36.

The first busbar 32 can be configured to electrically connect the plurality of first electrodes 36 of the plurality of battery cells 14 to realize a connection among the first electrodes 36 of various battery cells 14, which is conducive to forming a series connection, a parallel connection, or a series-parallel connection among the plurality of battery cells 14. The first busbar 32 is disposed at the outer side surface of the shell 12, which also facilitates maintenance of the first busbar 32.

The first busbar 32 may be made of a material including, but not limited to, copper, aluminum, nickel, or an alloy. Alternatively, the first busbar 32 may be connected to the first electrode 36 through welding (such as laser welding). In FIG. 9, the first busbar 32 is disposed at a bottom of the first housing 22.

The first electrode 36 may be a positive electrode or a negative electrode. In an embodiment, in two adjacent battery cells 14, one first electrode 36 may be the positive electrode while another first electrode 36 may be the negative electrode. In an embodiment, in the two adjacent battery cells 14, the one first electrode 36 may be the positive electrode while another first electrode 36 may also be the positive electrode. In an embodiment, in the two adjacent battery cells 14, the one first electrode 36 may be the negative electrode while another first electrode 36 may also be the negative electrode.

In some embodiments, with reference to FIG. 9, the energy storage power supply 100 includes a cover plate 42. The shell 12 has a receiving chamber 38 formed at an outer side surface of the shell 12 corresponding to the first support 20. The cover plate is disposed at the outer side surface of the shell 12 and covers the receiving chamber 38 to form the receiving space. The first busbar 32 is disposed in the receiving space.

In this way, the first busbar 32 can be protected.

Specifically, the first busbar 32 is connected to the first electrode 36 through the first through hole 34 and is disposed in the receiving space, allowing the shell 12 to protect the first busbar 32. Moreover, the first busbar 32 is recessed into the shell 12, in such a manner that the first busbar 32 is less likely to be accidentally touched by the user. In FIG. 9, the receiving chamber 38 is located at a bottom surface of the first housing 22.

In some embodiments, with reference to FIG. 9, the energy storage power supply 100 includes a first acquisition board 40 disposed in the receiving space and electrically connected to the first busbar 32.

In this way, parameter information of the battery cell 14 can be acquired, and the first acquisition board 40 can be protected.

Specifically, the first acquisition board 40 is electrically connected to the first busbar 32, enabling the first acquisition board 40 to acquire the parameter information of the battery cell 14 through the first busbar 32. The parameter information of the battery cell 14 includes, but is not limited to, temperature, voltage, current, or the like of the battery cell 14. The energy storage power supply 100 may include a battery management circuit board 44 provided with a Battery Management System (BMS), which can be electrically connected to the first acquisition board 40 to acquire the parameter information of the battery cell 14 through the first acquisition board 40.

The first acquisition board 40 may be made of a material including, but not limited to, copper, aluminum, nickel, or an alloy. Alternatively, the first acquisition board 40 may be connected to the first busbar 32 through welding (such as laser welding). In FIG. 9, the first acquisition board 40 is disposed at the bottom of the first housing 22.

Alternatively, the energy storage power supply 100 includes a sealing ring (not illustrated in the figures). The sealing ring is configured to sealingly connect an edge of the cover plate 42 and an edge of the receiving chamber 38, enhancing sealability of the receiving space. Additionally, the receiving chamber 38 is recessed into a surface of the shell 12, to prevent the first busbar 32 and the first acquisition board 40 from being damaged due to direct contact with an external object during assembly.

In some embodiments, with reference to FIG. 9, the second support 46 has a plurality of second accommodation recesses 48, and the main body 30 has another end fitted in a corresponding second accommodation recesses 48 of the plurality of second accommodation recesses 48.

Specifically, with reference to FIG. 3, FIG. 6, and FIG. 9, the lower end of the main body 30 is fitted in the corresponding first accommodation recess 28 of the plurality of first accommodation recesses 28, while the upper end of the main body 30 is fitted in the corresponding second accommodation recess 48 of the plurality of second accommodation recesses 48, allowing for the battery cell 14 to be limited within both the first accommodation recess 28 and the second accommodation recess 48.

Alternatively, the plurality of second accommodation recesses 48 are arranged in a matrix, and thus the battery cells 14 are also arranged in a matrix. In this way, the battery cells 14 are arranged in an organized manner, which is conducive to improving the space utilization of the energy storage power supply 100. A shape of the second accommodation recess 48 matches that of the main body 30 to fix and limit the battery cell 14 more effectively. In FIG. 9, the main body 30 is in a shape of a cylinder, and correspondingly, the second accommodation recess 48 is also in a shape of a cylinder.

The second accommodation recess 48 can constrain the battery cell 14 to prevent the battery cell 14 from shaking during use of the energy storage power supply 100, which could otherwise affect normal use of the energy storage power supply 100. The first accommodation recess 28 and the second accommodation recess 48 may be aligned in the up-down direction.

In some embodiments, with reference to FIG. 8, the energy storage power supply 100 includes a second busbar 50 located in the accommodation chamber 18. Each of the plurality of second accommodation recesses 48 has a second through hole 52 at a bottom surface of the second accommodation recess 48. The second busbar 50 is connected to a second electrode 54 of the two electrodes of the battery cell 14 through the second through hole 52. The second electrode 54 is formed at the other end of the main body 30 fitted in the corresponding second accommodation recess 48 of the plurality of second accommodation recesses 48.

In the way, the plurality of battery cells 14 can be electrically connected by the second busbar 50.

Specifically, in an embodiment, with reference to FIG. 8, the second electrode 54 may pass through the second through hole 52 and be connected to the second busbar 50. In an embodiment, the second busbar 50 may pass through the second through hole 52 and be connected to the second electrode 54.

The second busbar 50 can electrically connect the plurality of second electrodes 54 of the plurality of battery cells 14 to realize a connection among the second electrodes 54 of various battery cells 14, which is conducive to forming a series connection, a parallel connection, or a series-parallel connection among the plurality of battery cells 14.

The second busbar 50 may be made of a material including, but not limited to, copper, aluminum, nickel, or an alloy. Alternatively, the second busbar 50 may be connected to the second electrode 54 through welding (such as laser welding).

The second electrode 54 may be a positive electrode or a negative electrode. In an embodiment, in two adjacent battery cells 14, one second electrode 54 may be a positive electrode while another second electrode 54 may be a negative electrode. In an embodiment, in the two adjacent battery cells 14, one second electrode 54 may be the positive electrode while another second electrode 54 may also be the positive electrode. In an embodiment, in the two adjacent battery cells 14, one second electrode 54 may be the negative electrode while another second electrode 54 may also be the negative electrode.

Alternatively, in one battery cell 14, the first electrode 36 and the second electrode 54 are of opposite polarities.

In some embodiments, with reference to FIG. 8, the energy storage power supply 100 includes a second acquisition board 56 located in the accommodation chamber 18 and electrically connected to the second busbar 50.

In this way, the parameter information of the battery cell 14 can be acquired.

Specifically, the second acquisition board 56 is electrically connected to the second busbar 50, enabling the second acquisition board 56 to acquire the parameter information of the battery cell 14 through the second busbar 50. The parameter information of the battery cell 14 includes, but is not limited to, temperature, voltage, current, or the like of the battery cell 14. The BMS can be electrically connected to the second acquisition board 56 to acquire the parameter information of the battery cell 14 through the second acquisition board 56.

The second acquisition board 56 may be made of a material including, but not limited to, copper, aluminum, nickel, or an alloy. Alternatively, the second acquisition board 56 may be connected to the second busbar 50 through welding (such as laser welding).

In some embodiments, with reference to FIG. 5, FIG. 6, and FIG. 8, the energy storage power supply 100 includes a battery management circuit board 44 disposed in the accommodation chamber 18. The first busbar 32 is electrically connected to the battery management circuit board 44. The inverter 16 is disposed at a side of the battery management circuit board 44 away from the first busbar 32.

In this way, the battery management circuit board 44 acquire the parameter information of the battery cell 14 through the first busbar 32.

Specifically, the battery management circuit board 44 includes the BMS that can be electrically connected to the first busbar 32. In this embodiment, the battery management circuit board 44 can be electrically connected to the first busbar 32 by the first acquisition board 40, acquiring the parameter information (including but not limited to voltage, current, temperature, or the like) of the battery cell 14. The BMS can control an operation of the energy storage power supply 100 based on the parameter information of the battery cell 14. Alternatively, the battery management circuit board 44 is fixedly connected to the second support 46 by means of a bolted connection.

Alternatively, the battery management circuit board 44 may be electrically connected to the second busbar 50 by the second acquisition board 56, acquiring the parameter information (including but not limited to voltage, current, temperature, or the like) of the battery cell 14.

Alternatively, the energy storage power supply 100 includes a spacer 58. The spacer 58 is disposed not only between the battery management circuit board 44 and the second busbar 50 but also between the battery management circuit board 44 and the second acquisition board 56. In this way, the battery management circuit board 44 can be ensured to be insulated from each of the second busbar 50 and the second acquisition board 56 to some extent. The spacer 58 may be made of an insulating material or coated with an insulating layer at a surface of the spacer 58. The insulating material includes, but is not limited to, plastic, a mica sheet, etc.

Alternatively, the battery management circuit board 44 includes two first connectors, the second acquisition board 56 is provided with a second connector, and the first acquisition board 40 is provided with a third connector. One of the two first connectors and the second connector may be connected to a first connection device, while another of the two first connectors and the third connector may be connected to a second connection device, forming an electrical connection path.

In some embodiments, the accommodation chamber 18 has a third through hole 57 at a side wall of the accommodation chamber 18. The receiving space is in communication with the accommodation chamber 18 through the third through hole 57. The first busbar 32 is electrically connected to the battery management circuit board 44 through the third through hole 57.

In this way, with the third through hole 57, internal wiring within the shell 12 can be facilitated to enable an electrical connection between the first busbar 32 and the battery management circuit board 44.

Specifically, with reference to FIG. 9, the third through hole 57 is formed at a bottom surface of the accommodation chamber 18, and the first acquisition board 40 is electrically connected to the first busbar 32. The first acquisition board 40 may be electrically connected to the battery management circuit board 44 through the third through hole 57.

For example, the first acquisition board 40 is provided with the third connector that can extend into the third through hole 57. The second connection device has an end that may be connected to the third connector through the third through hole 57 and another end that may be connected to the first connector of the battery management circuit board 44. In this way, the electrical connection between the first busbar 32 and the battery management circuit board 44 can be realized.

By electrically connecting the first busbar 32 to the battery management circuit board 44 through the third through hole 57 and forming the third through hole 57 at the side wall of the accommodation chamber 18, a space inside the energy storage power supply 100 is fully utilized, which helps improve the space utilization of the energy storage power supply 100.

In some embodiments, the first electrode 36 is provided with an explosion-proof valve 59. The explosion-proof valve 59 is in communication with the receiving space through the first through hole 34.

Accordingly, during thermal runaway of the battery cell 14, substances ejected from the explosion-proof valve 59 can be sprayed through the first through hole 34 into the receiving space to prevent spread of the thermal runaway to some extent.

Specifically, during an operation of the battery cell 14, a gas may be released from an interior of the battery cell 14, causing a pressure within the battery cell 14 to increase. When the pressure becomes excessive, the explosion-proof valve 59 can rupture to release substances (e.g., a gas, a liquid, etc.) inside the battery cell 14. Since the explosion-proof valve 59 is in communication with the receiving space through the first through hole 34, the substances ejected from the explosion-proof valve 59 can be sprayed into the receiving space to isolate the substances ejected by the explosion-proof valve 59 from other battery cells 14 in the accommodation chamber. Therefore, the thermal runaway of one battery cell 14 can be prevented from spreading to other battery cells 14 to some extent, enhancing safety of the energy storage power supply 100.

In some embodiments, the inverter 16 is disposed at a side of the second support 46 away from the battery cell 14.

In this way, a quantity of components required for the energy storage power supply can be reduced.

Specifically, with reference to FIG. 5, FIG. 6, and FIG. 8, the battery cell 14 may be sandwiched by the first support 20 and the second support 46 in the up-down direction. Since the inverter 16 is disposed at the side of the second support 46 away from the battery cell 14, the second support 46 can be used to fix the inverter 16, which can reduce the need for the additional component for fixing the inverter 16. In this way, the volume and the weight of the energy storage power supply 100 can be reduced to some extent, improving the portability and lowering the manufacturing costs of the energy storage power supply 100.

In some embodiments, with reference to FIG. 5, FIG. 6, and FIG. 8, the second support 46 is provided with a plurality of connection bases 60 protruding from a side surface of the second support 46 away from the battery cell 14, and the inverter 16 is mounted on the plurality of connection bases 60.

In this way, a heat dissipation space for the inverter 16 can be increased.

Specifically, during an operation of the inverter 16, the direct current output from the battery cell 14 can be converted into the alternating current and output to an external device. During this process, the inverter 16 generates significant heat and requires heat dissipation. By mounting the inverter 16 on the plurality of connection bases 60, the inverter 16 can be far away from the battery management circuit board, which helps to increase the heat dissipation space for the inverter 16.

Alternatively, the inverter 16 may be mounted on the connection base 60 using a bolt, a snap, or the like.

Alternatively, the plurality of connection bases 60 form the accommodation space 62, and the battery management circuit board 44 and the spacer 58 are located in the accommodation space 62, which helps to improve the space utilization of the energy storage power supply 100.

In some embodiments, with reference to FIG. 3, the first support 20 is provided with a first connection member 64, and the second support 46 is provided with a second connection member 66. The first connection member 64 is connected to the second connection member 66 to allow the battery cell 14 to be sandwiched by the first support 20 and the second support 46.

In this way, structural strength of the connection member can be ensured to some extent.

Specifically, each of the first connection member 64 and the second connection member 66 is in an elongated shape. A length direction of the first connection member 64 extends towards the second support 46, while a length direction of the second connection member 66 extends towards the first support 20. The first connection member 64 and the second connection member 66 may be connected by means including, but not limited to, a bolt, a snap, or the like. In FIG. 3, the first connection member 64 and the second connection member 66 are connected by a bolt.

Alternatively, a plurality of first connection members 64 and a plurality of second connection members 66 are provided and of a same quantity. The plurality of first connection members 64 may be arranged along an edge of the first support 20. The plurality of second connection members 66 may be arranged along an edge of the second support 46. Each first connection member 64 is connected to a corresponding second connection member 66 of the plurality of second connection members 66, enhancing stability of a connection between the first support 20 and the second support 46.

In a conventional configuration, the connection member extends only from the first support 20 or the second support 46, which results in a long overall length of the connection member, compromising strength of the connection member. In comparison with the conventional configuration, the embodiments of the present disclosure provide that the first support 20 and the second support 46 are connected by the first connection member 64 and the second connection member 66, which allows for a short length of each of the first connection member 64 and the second connection member 66, ensuring structural strength of the connection member to some extent.

Alternatively, the first connection member 64 and the second connection member 66 may be detachably connected.

In some embodiments, with reference to FIG. 6, the shell 12 includes a first housing 22 and a second housing 24. The first housing 22 is connected to the second housing 24. The first support 20 and the first housing 22 are integrally formed.

In this way, stability of fixing the battery cell 14 can be enhanced to some extent.

Specifically, the battery cell 14 has an end mounted at the first support 20. The first support 20 and the first housing 22 are integrally formed. A connection between the first support 20 and the first housing 22 is relatively stable. In this way, the stability of fixing the battery cell 14 can be enhanced to some extent.

Alternatively, the shell 12 may be made of plastic, and the first housing 22 and the first support 20 may be integrally manufactured using the injection molding process, which can improve an efficiency and lower costs.

In some embodiments, the second housing 24 is provided with a handle 97.

In this way, it is convenient for the user to move the energy storage power supply 100.

Specifically, the energy storage power supply 100 may be movably placed in different locations. When moving the energy storage power supply 100, the user can carry the energy storage power supply 100 by lifting the handle 97, which makes it convenient for the user to move the energy storage power supply 100.

Alternatively, in an embodiment, with reference to FIG. 1 to FIG. 9, the handle 97 may be a separate handle rotatably disposed at the second housing 24. Alternatively, in an embodiment, the handle 97 and the second housing 24 are integrally formed. The handle 97 may be made of a same material as the second housing 24 or a different material from the second housing 24.

In some embodiments, with reference to FIG. 3 to FIG. 7, the first housing 22 is provided with a first connection post 68 inside the first housing 22, and the second housing 24 is provided with a second connection post 70 inside the second housing 24. The first connection post 68 is connected to the second connection post 70 to connect the first housing 22 to the second housing 24.

In this way, structural strength of the connection post can be ensured to some extent.

Specifically, each of the first connection post 68 and the second connection post 70 is in an elongated shape. A length direction of the first connection post 68 extends towards the second housing 24, while a length direction of the second connection post 70 extends towards the first housing 22. The first connection post 68 and the second connection post 70 may be connected by means including, but not limited to, a bolt, a snap, or the like.

Alternatively, a plurality of first connection posts 68 and a plurality of second connection posts 70 are provided and of a same quantity. The plurality of first connection posts 68 are arranged at positions close to a side wall of the first housing 22. The plurality of second connection posts 70 are arranged at positions close to a side wall of the second housing 24. Each first connection post 68 is connected to a corresponding second connection post 70 of the plurality of second connection posts 70, enhancing the stability of the connection between the first support 20 and the second support 46.

In a conventional configuration, the connection post extends only from the first housing 22 or the second housing 24, which results in a long overall length of the connection post, compromising strength of the connection post. In comparison with the conventional configuration, the embodiments of the present disclosure provide that the first housing 22 and the second housing 24 are connected by the first connection post 68 and the second connection post 70, which allows for a short length of each of the first connection post 68 and the second connection post 70, ensuring structural strength of the connection post to some extent.

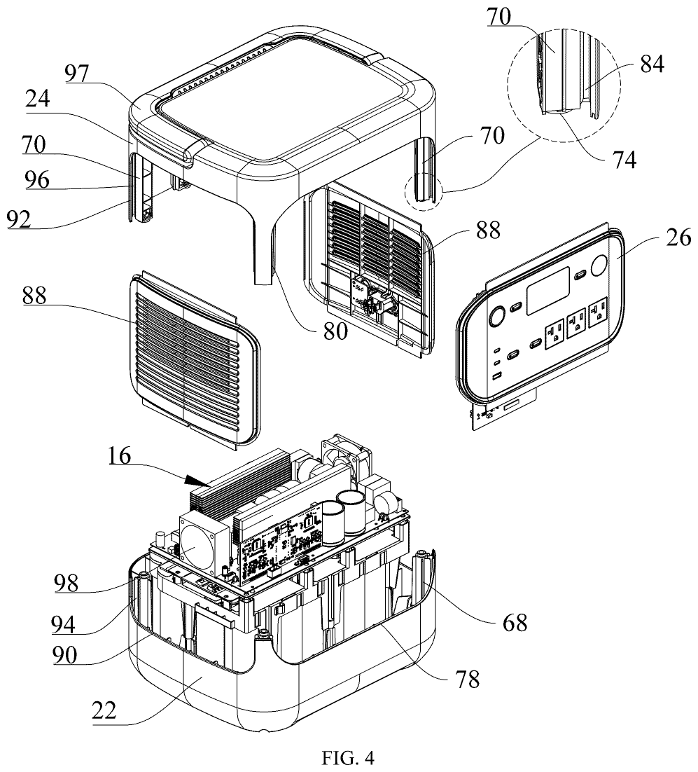

In some embodiments, with reference to FIG. 4 and FIG. 8, the first connection post 68 has a first connection hole 72, and the second connection post 70 has a second connection hole 74. The first connection post 68 and the second connection post 70 are connected by a third connection member (not illustrated in the figures) through the first connection hole 72 and the second connection hole 74.

In this way, the first connection post 68 and the second connection post 70 can be connected.

Specifically, in an embodiment, one of the first connection hole 72 and the second connection hole 74 may be a through hole, another of the first connection hole 72 and the second connection hole 74 may be a threaded hole, and the third connection member may include a bolt. The bolt can pass through the through hole and be connected to the threaded hole, enabling the first connection post 68 and the second connection post 70 to be connected.

In an embodiment, the first connection hole 72 and the second connection hole 74 are both threaded holes, and the third connection member may include a bolt. The bolt may be connected to each of a threaded hole in the first connection post 68 and a threaded hole in the second connection post 70, connecting the first connection post 68 to the second connection post 70.

In an embodiment, the first connection hole 72 and the second connection hole 74 are both through holes, and the third connection member may include a pin. The pin can pass through each of a through hole in the first connection post 68 and a through hole in the second connection post 70, and may be connected to each of the two through holes in an interference fit, connecting the first connection post 68 to the second connection post 70.

Alternatively, the first connection post 68 and the second connection post 70 may be detachably connected. Alternatively, the first housing 22, the first connection post 68, the first connection member 64, and the first support 20 may be integrally formed. The second housing 24 and the second connection post 70 may also be integrally formed.

In some embodiments, with reference to FIG. 1 to FIG. 8, the energy storage power supply 100 includes a panel 26, and the shell 12 has a first opening 76 at which the panel 26 is mounted.

In this way, the panel 26 and the shell 12 may be formed separately, which can reduce types of materials used and enhance material versatility.

Specifically, the panel 26 has a current output port (such as an alternating current output port) and is mounted at the first opening 76. The panel 26 and the shell 12 may be formed separately. Given that the alternating current output ports of the energy storage power supplies 100 may vary by country, differing parts of outer appearances of the energy storage power supplies 100 in different countries mainly lie in the panel 26, while other parts remain substantially identical. In the embodiment of the present disclosure, the panel 26 may be formed separately. Consequently, for the energy storage power supplies 100 for different countries, only the panel 26 needs to be designed and manufactured differently as desired, without a need to redesign and manufacture the entire shell 12 for different specifications, which can reduce types of materials used and enhance the material versatility.

Alternatively, the panel 26 is detachably mounted at the first opening 76, which facilitates maintenance of the panel. Alternatively, in other embodiments, the panel 26 and the shell 12 (such as the first housing 22 or the second housing 24) may also be integrally formed.

In the embodiments of the present disclosure, the first housing 22 and second housing 24 are arranged in the up-down direction, and the battery cell 14 is arranged in a vertical direction. The first housing 22, the battery cell 14, the second support 46, the battery management circuit board 44, the inverter 16, and the second housing 24 are sequentially arranged from bottom to top. The panel 26 is disposed at a side surface of the energy storage power supply 100. The cover plate 42 is disposed at a bottom of the energy storage power supply 100. Since a gap may exist at a connection between the cover plate 42 and the first housing 22 and affects an outer appearance of a product, disposing the cover plate 42 at the bottom of the energy storage power supply 100 makes the gap less visible. Additionally, the weight of the energy storage power supply 100 itself can reinforce a connection between the cover plate 42 and the second housing 24, improving sealing performance.

In some embodiments, with reference to FIG. 4 and FIG. 7, the shell 12 includes a first housing 22 and a second housing 24. The first housing 22 has a first groove 78. The second housing 24 has a second groove 80. The first housing 22 is connected to the second housing 24, in such a manner that the first groove 78 and the second groove 80 are joined to form the first opening 76. The first housing 22 has a first connection recess 82. The second housing 24 has a second connection recess 84. The panel 26 is provided with two first connection tabs (not illustrated in the figures). The two first connection tabs are respectively inserted into the first connection recess 82 and the second connection recess 84 to enable the panel 26 to be mounted at the first opening 76.

In this way, the panel 26 can be mounted at the first opening 76 through the first connection tab and the second connection recess 84.

Specifically, in this embodiment, the first housing 22 and the second housing 24 are connected by the first connection post 68 and the second connection post 70. The first connection post 68 has the first connection recess 82 at a part of the first connection post 68 close to the first opening 76. The second connection post 70 has the second connection recess 84 at a part of the second connection post 70 close to the first opening 76. The two first connection tabs at the panel 26 are respectively inserted into the first connection recess 82 and the second connection recess 84 to enable the panel 26 to be mounted at the first opening 76.

Alternatively, a fastener may be used to fix the panel 26, which enables the panel 26 to be less likely to fall off from the shell 12.

Further, each of the part of the first connection post 68 close to the first opening 76 and the part of the second connection post 70 close to the first opening 76 has a snapping groove, and the panel 26 is provided with a snap at an outer periphery of the panel 26. The panel 26 is snapped at the first opening 76 through connecting the snap and the snapping groove.

In some embodiments, the shell 12 has a second opening 86, and the energy storage power supply 100 further includes a ventilation panel 88 mounted at the second opening 86.

In this way, heat dissipation performance of the energy storage power supply 100 can be improved to some extent.

Specifically, the ventilation panel 88 has a ventilation hole. The accommodation chamber 18 of the shell 12 can be in communication with an outside of the shell 12 through the ventilation hole. Therefore, air circulation can be enabled between an inside and the outside of the shell 12, which can improve the heat dissipation performance of the energy storage power supply 100 to some extent.

In an embodiment, with reference to FIG. 4 and FIG. 7, the shell 12 includes the first housing 22 and the second housing 24. The first housing 22 has a third groove 90. The second housing 24 has a fourth groove 92. When the first housing 22 is connected to the second housing 24, the third groove 90 and the fourth groove 92 are joined to form the second opening 86 in the shell 12. The first connection post 68 has a third connection recess 94 at a part of the first connection post 68 close to the second opening 86. The second connection post 70 has a fourth connection recess 96 at a part of the second connection post 70 close to the second opening 86. The ventilation panel 88 is provided with two second connection tabs. The two second connection tabs are respectively inserted into the third connection recess 94 and the fourth connection recess 96 to enable the ventilation panel 88 to be mounted at the second opening 86.

With reference to FIG. 4 and FIG. 7, the energy storage power supply 100 is provided with two ventilation panels 88. The two ventilation panels 88 are respectively disposed at the second openings 86 at a left side and a right side of the shell 12. The energy storage power supply 100 includes two heat dissipation fans 98 mounted at the inverter 16. One of the two heat dissipation fans 98 is located close to the ventilation panel 88 at the left side, while another of the two heat dissipation fans 98 is located close to the ventilation panel 88 at the right side. Alternatively, the two heat dissipation fans 98 are configured to blow air in one direction. For example, the two heat dissipation fans 98 are configured to blow air towards the left side during an operation, in such a manner that an airflow from the ventilation panel 88 at the left side to the ventilation panel 88 at the left side is formed inside the shell 12, which enables heat dissipation for electrical components (including but not limited to the inverter 16 and the battery cell 14) inside the shell 12. Alternatively, the heat dissipation fan 98 may also be disposed at the second support 46. The present disclosure does not impose any specific limitation on a quantity of heat dissipation fans 98.

Further, each of the part of the first connection post 68 close to the second opening 86 and the part of the second connection post 70 close to the second opening 86 has a snapping groove, and the ventilation panel 88 is provided with a snap at an outer periphery of the ventilation panel 88. The ventilation panel 88 is snapped at the second opening 86 through connecting the snap and the snapping groove.

In an embodiment, the ventilation panel 88 may be integrally formed with the first housing 22 or the second housing 24. In an embodiment, the ventilation panel 88 may be detachably mounted at the second opening 86.

Alternatively, the cover plate 42 is provided with a foot pad 95 at a bottom of the cover plate 42. The foot pad 95 can provide anti-slip and support functions.

Reference throughout this specification to “an embodiment”, “some embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and the spirit of the present disclosure. The scope of the present disclosure shall be defined by the claims as appended and their equivalents.

What is claimed is:

1. An energy storage power supply, comprising:
a shell having an accommodation chamber and a receiving space, wherein the accommodation chamber is provided with a first support at an inner side surface of the accommodation chamber, the first support having a plurality of first accommodation recesses, and each of the plurality of first accommodation recesses having a first through hole at a bottom of the first accommodation recess;
a battery cell located in the accommodation chamber and disposed at the first support, the battery cell comprising a main body and two electrodes respectively disposed at two ends of the main body in a length direction of the main body, wherein the main body has an end fitted in a corresponding first accommodation recess of the plurality of first accommodation recesses and is in communication with the receiving space through the first through hole;
a second support fixedly connected to the shell and disposed at a side of the battery cell away from the first support, the battery cell being sandwiched between the first support and the second support; and
an inverter located in the accommodation chamber and electrically connected to the battery cell.

2. The energy storage power supply according to claim 1, further comprising a first busbar disposed in the receiving space, the first busbar being electrically connected to a first electrode of the two electrodes of the battery cell through the first through hole, and the first electrode being formed at the end of the main body fitted in the corresponding first accommodation recess of the plurality of first accommodation recesses.

3. The energy storage power supply according to claim 2, further comprising a cover plate, wherein:
the shell has a receiving chamber formed at an outer side surface of the shell corresponding to the first support; and
the cover plate is disposed at the outer side surface of the shell and covers the receiving chamber to form the receiving space.

4. The energy storage power supply according to claim 2, further comprising a first acquisition board disposed in the receiving space and electrically connected to the first busbar.

5. The energy storage power supply according to claim 1, wherein the second support has a plurality of second accommodation recesses,
wherein the main body has another end fitted in a corresponding second accommodation recess of the plurality of second accommodation recesses.

6. The energy storage power supply according to claim 5, further comprising a second busbar located in the accommodation chamber, wherein:
each of the plurality of second accommodation recesses has a second through hole at a bottom surface of the second accommodation recess;
the second busbar is connected to a second electrode of the two electrodes of the battery cell through the second through hole; and
the second electrode is formed at the other end of the main body fitted in the corresponding second accommodation recess of the plurality of second accommodation recesses.

7. The energy storage power supply according to claim 6, further comprising a second acquisition board located in the accommodation chamber and electrically connected to the second busbar.

8. The energy storage power supply according to claim 2, further comprising a battery management circuit board disposed in the accommodation chamber, wherein:
the first busbar is electrically connected to the battery management circuit board; and
the inverter is disposed at a side of the battery management circuit board away from the first busbar.

9. The energy storage power supply according to claim 8, wherein the accommodation chamber has a third through hole at a side wall of the accommodation chamber, the receiving space being in communication with the accommodation chamber through the third through hole, and the first busbar being electrically connected to the battery management circuit board through the third through hole.

10. The energy storage power supply according to claim 2, wherein the first electrode is provided with an explosion-proof valve, the explosion-proof valve being in communication with the receiving space through the first through hole.

11. The energy storage power supply according to claim 1, wherein the inverter is disposed at a side of the second support away from the battery cell.

12. The energy storage power supply according to claim 11, wherein the second support is provided with a plurality of connection bases protruding from a side surface of the second support away from the battery cell, the inverter being mounted on the plurality of connection bases.

13. The energy storage power supply according to claim 12, wherein:
the first support is provided with a first connection member; and
the second support is provided with a second connection member, the first connection member being connected to the second connection member to allow the battery cell to be sandwiched by the first support and the second support.

14. The energy storage power supply according to claim 1, wherein the shell comprises a first housing and a second housing connected to the first housing, the first support and the first housing being integrally formed.

15. The energy storage power supply according to claim 14, wherein the second housing is provided with a handle.

16. The energy storage power supply according to claim 14, wherein:
the first housing is provided with a first connection post inside the first housing; and
the second housing is provided with a second connection post inside the second housing, the first connection post being connected to the second connection post to connect the first housing to the second housing.

17. The energy storage power supply according to claim 1, further comprising a panel,
wherein the shell has a first opening at which the panel is mounted.

18. The energy storage power supply according to claim 17, wherein the shell comprises a first housing and a second housing, wherein:
the first housing has a first groove;
the second housing has a second groove, the first housing being connected to the second housing in such a manner that the first groove and the second groove are joined to form the first opening;
the first housing has a first connection recess;
the second housing has a second connection recess; and
the panel is provided with two first connection tabs, the two first connection tabs being respectively inserted into the first connection recess and the second connection recess to enable the panel to be mounted at the first opening.

19. The energy storage power supply according to claim 1, wherein:
the shell has a second opening; and
the energy storage power supply further comprises a ventilation panel mounted at the second opening.

20. The energy storage power supply according to claim 1, further comprising two heat dissipation fans mounted at the inverter, the two heat dissipation fans being configured to blow air in one direction.
